(19) United States
(12) Patent Application Publication
(10) Pub. No.: US 2008/0047646 A1
(43) Pub. Date: Feb. 28, 2008

(54) Inner Liner of Pneumatic Tire

(76) Inventors: Gi-Il Hong, Gyeongsangbuk-do (KR); Gi-Sang Song, Gyeongsangbuk-do (KR); Sang-Hyun Baek, Gyeongsangbuk-do (KR)

Correspondence Address: BIRCH STEWART KOLASCH & BIRCH, PO BOX 747, FALLS CHURCH, VA, 22040-0747, US

(21) Appl. No.: 11/630,618

(22) PCT Filed: Jun. 24, 2005
(86) PCT No.: PCT/KR05/01979

§ 371 Date: Dec. 22, 2006

(30) Foreign Application Priority Data
Jun. 24, 2004 (KR) 10 -2004-0047568

(51) Int. Cl. B60C 5/14

(52) U.S. Cl. 152/510

(57) ABSTRACT

The present invention provides an inner liner of pneumatic tires that is formed from a non-drawn film of a polymer composition including 60 to 90 wt. % of a thermoplastic resin and 10 to 40 wt. % of an elastomer to have an oxygen permeation rate of less than 15×10⁻³ ccm/m² 24 hratm, and a fracture elongation of more than 200% at the room temperature. The tire thus manufacture has no fracture under a severe deformation during the tire shaping process, facilitating the tire manufacture, and exhibits an air permeation preventive property as an excellent air permeation preventive layer.

### TECHNICAL FIELD

The present invention relates to an inner liner of pneumatic tires. More specifically, the present invention relates to an inner liner including a thermoplastic resin and an elastomer

### BACKGROUND ART

The most important problem the automobile industry is faced with is the reduction of fuel consumption rate. This increasingly requires the reduction of the weight of tires.

Currently, the inside of tires has an inner liner or an air permeation preventing layer that is made of a halogenated butyl rubber or another rubber having low air permeation.

However, the halogenated butyl rubber employed as an inner liner or an air permeation preventing layer has a high hysteresis loss, causing a ripple on the inner rubber of a carcass layer and the air permeation preventing layer after a vulcanization of the tire and thereby deforming both the carcass layer and the air permeation preventing layer. This leads to an increased rolling resistance.

As a solution of this problem, a rubber sheet called “tie rubber” having a low hysteresis loss is inserted between the air permeation preventing layer (halogenated butyl rubber) and the carcass layer. The insertion of the rubber sheet increases the total thickness of the tire layer above 1 mm (1,000 μm) in addition to the thickness of the air permeation preventing layer made of a halogenated butyl rubber. This results in the increased weight of the complete tire.

In an attempt to solve this problem, there have been suggested techniques of employing different materials for the air permeation preventing layer of pneumatic tires instead of such a conventional rubber material as halogenated butyl rubber having low air permeation.

For example, Japanese Patent Laid Open No. 6-40207 proposes a technique of providing an air permeation preventing layer in the inside of the tire by laminating a low air permeation layer including a polyvinylidene chloride film or an ethylene-vinyl alcohol copolymer film and an adhesive layer including a polyolefin film, an aliphatic polyamide film, or a polyurethane film to form a thin film, affixing the thin film to the inner side of the green tire consisting of non-vulcanized rubber to make the adhesive layer in contact with the carcass layer, and then vulcanizing and shaping the green tire.

The use of a thin air permeation preventing layer makes it possible to reduce the weight of the tire without deteriorating the maintenance of pneumatics.

However, the thermoplastic multi-layer film, if used for an inner liner or another air permeation preventing layer, has a low elongation with respect to repeated deformations while in use, causing a lot of cracks on it and hence a deterioration of air tightness.

In the conventional tire manufacturing method that requires a step of shaping an inner liner, the thermoplastic film commercially available encounters oriented crystallization caused by drawing and heat crystallization by thermosetting after drawing and annealing processes, providing poor elongation against deformation in the shaping process with a consequence of fracture. In conclusion, the conventional manufacturing methods make it impossible to realize the fabrication of tires from thermoplastic films commercially available.

### DISCLOSURE OF INVENTION

In an attempt to derive an alternative method for employing a thermoplastic resin for an inner liner, the inventors of the present invention have found out that a non-drawn film formed from a polymer composition including a mixture of an elastomer and a thermoplastic resin excellent in air permeation preventive property can be used as an inner liner to guarantee high elongation against deformation during the shaping process and a good air permeation preventive property.

It is therefore an object of the present invention to provide an inner liner for tires that is excellent in air permeation preventive property without having fractures caused by deformation during the shaping process at the room temperature.

To achieve the above object of the present invention, there is provide an inner liner of pneumatic tires that is formed from a non-drawn film of a polymer composition including 60 to 90 wt. % of a thermoplastic resin and 10 to 40 wt. % of an elastomer, the non-drawn film having an oxygen permeation rate of less than 15×10⁻³ ccm/m²·24 hr·atm, and a fracture elongation of more than 200% at the room temperature.

The present invention will be described in further detail as follows.

The inner liner of pneumatic tires according to the present invention is a non-drawn film obtained from a polymer composition including a mixture of a thermoplastic resin and an elastomer.

The tire manufacturing process necessarily includes a shaping process, during which the film is formed to have the shape of a tire with an air blower at the room temperature. Accordingly, the inner liner must not have any fracture caused by the deformation in the shaping process. However, most of the films commercially available are not durable against deformation from oriented crystallization, heat crystallization and oriented crystallization after the drawing and annealing processes.

For that reason, the present invention applies deformation during the shaping process in the tire manufacturing process as a conception of film drawing at the room temperature.

Instead of forming a drawn film from a polymer composition including a thermoplastic resin and an elastomer, a non-drawn film is used to produce an inner liner without drawing or annealing so as to secure ductility against deformation in the shaping process.

In other words, the inner liner of the present invention has a fracture elongation of more than 200%, so it hardly undergoes fracture caused by deformation in the shaping process.

The inner liner of the present invention also has an oxygen permeation rate of less than 15×10⁻³ ccm/m²·24 hr·atm to provide good air tightness and to prevent oxidation of the rubber layer or the like caused by oxygen permeation.

The specific polymer composition for the non-drawn film of the present invention is as follows. The specific examples of the thermoplastic resin as used herein may include polyamide resins, e.g., nylon 6, nylon 66, nylon 46, nylon 11, nylon 12, nylon 610, nylon 612, nylon 6/66 copolymer, nylon 6/66/610 copolymer, nylon MXD, nylon 6T, nylon 6/6T copolymer, nylon 66/PP copolymer, or nylon 66/PPS copolymer; N-alkoxyalkylated polyamide resins, e.g., methoxymethylated nylon 6, methoxymethylated nylon 6-610, or methoxymethylated nylon 612; polyester resins, e.g., polybutyleneterephthalate, polyethyleneterephthalate, polyethyleneisophthalate, PET/PEI copolymer, polyacrylate, polybutylenenaphthalate, liquid crystal polyester, polyoxyalkylenediimido 2-oxygen/polybutylate terephthalate copolymer, or other aromatic polyesters; polynitrile resins, e.g., polyacrylonitrile(PAN), polymethacrylonitrile, acrylonitrile/styrene copolymer (AS), methacrylonitrile/styrene copolymer, or methacrylonitrile/styrene/butadiene copolymer; polymethacrylate resins, e.g., polymethylmethacrylate(PMMA), or polyethylmethacrylate; polyvinyl resins, e.g., vinyl acetate, polyvinyl alcohol (PVA), vinyl alcohol/ethylene copolymer (EVOH), polyvinylidenechloride(PVDC), polyvinylchloride(PVC), polyvinyl/polyvinylidenechloride copolymer, polyvinylidene chloride/methylacrylate copolymer, or polyvinylidenechloride/acrylonitrile copolymer; cellulose resins, e.g., cellulose acetate, or cellulose acetobutyrate; fluoride resins, e.g., polyvinylidenefluoride(PVDF), polyvinyl fluoride, polychlorofluoroethylene (PCTFE), or tetrafluoroethylene/ethylene copolymer; or amide resins, e.g., aromatic polyimide (PI), etc.

The elastomer compatible with these thermoplastic resins may include, if not specifically limited to, diene rubbers and their hydrogenated products, e.g., natural rubber, isoprene rubber, epoxidated natural rubber, styrene-butadiene rubber, butadiene rubber (high cis-butadiene rubber, or low cis-butadiene rubber), natural rubber-butadiene rubber, hydrogenated natural rubber-butadiene rubber, or hydrogenated styrene-butadiene rubber, olefin rubbers, e.g., ethylene-propylene rubber (EPDM), maleic acid-modified ethylene-propylene rubber, IIR, isobutylene and aromatic vinyl or diene monomer copolymer, acryl rubber, or ionomer; halogenated rubbers, e.g., BR-IIR, Cl-IIR, brominated isobutylene paramethylstyrene copolymer (Br-IPMS), CR, chlorohydrine rubber (CHR), chlorosulfonated polyethylene (CSM), chlorinated polyethylene (CM), or maleic acid-modified chlorinated polyethylene (M-CM); silicon rubbers, e.g., methylvinylsilicon rubber, dimethylsilicon rubber, or methylphenylvinylsilicon rubber; sulfur-containing rubbers, e.g., polysulfide rubber; fluoride rubbers e.g., vinylidene fluoride rubber, fluorine-containing vinylether rubber, tetrafluoroethylenepropylene rubber, fluorine-containing silicon rubber, or fluorine-containing phosphazene rubber; or thermoplastic elastomers, e.g., styrene elastomer, olefin elastomer, ester elastomer, urethane elastomer, polyamide elastomer, etc.

The composition of the thermoplastic resin and the elastomer can be determined according to the balance of film thickness, internal air permeation, and flexibility. Preferably, the polymer composition includes 60 to 90 wt. % of the thermoplastic resin and 10 to 40 wt. % of the elastomer. When the content of the elastomer exceeds 40 wt. %, the film of the polymer composition is not suitable for a tire inner liner because of its poor gas barrier property inadequate to the air insulation of the tire. With the content of the elastomer less than 10 wt. %, the film cannot realize the rubber-like elastomer features to give the difficulty in the manufacture of tires and make the tires vulnerable to fracture while running.

It is preferable that a suitable compatibility enhance is used as a third component when the thermoplastic resin is incompatible with the elastomer. The addition of such a compatibility enhancer deteriorates the interfacial tension between the thermoplastic resin and the elastomer to reduce the size of the rubber particles forming the dispersed phase, thereby helping the features of the two components realize more effectively. The compatible enhancer may include a copolymer having at least either one structure of the thermoplastic resin or the elastomer, or a copolymer structure having an epoxy group, a carbonyl group, a halogen group, an amine group, an oxazoline group, or a hydroxyl group that is reactive to the thermoplastic resin or the elastomer. The compatible enhancer is preferably selected depending on the types of the thermoplastic resin and the elastomer, and generally includes styrene/ethylene-butylene block copolymer (SEBS) and its maleic acid-modified product, EPDM, EPDM/styrene or EPDM/acrylonitrile graft copolymer and its maleic acid-modified product, styrene/malate copolymer, reactive phenoxine, etc. The content of the compatibility enhancer is, if not specifically limited to, 0.5 to 10 parts by weight with respect to 100 parts by weight of the thermoplastic resin and the elastomer.

In addition to the mentioned essential polymer components, a compatibility enhancer polymer or another polymer can be optionally used as long as it does not deteriorate the necessary properties of the polymer composition for tires. The use purpose of another polymer is improving the compatibility of the thennoplastic resin and the elastomer, enhancing the film forming ability of the materials and the heat resistance, and reducing the manufacture cost. The specific examples of such a material may include polyethylene, polypropylene, polystyrene, ABS, SBS, SEBS, polycarbonate, etc. The material may also include polyethylene, polypropylene and another olefin copolymers, their maleic acid-modified, or their derivative containing a glycidyl group. The polymer composition of the present invention may further include additives that can be mixed with a polymer formula, such as filler, carbon, powdered quartz, calcium carbonate, alumina, titan dioxide, etc.

The polymer composition thus obtained is subjected to melt-extrusion and quenching to produce a non-drawn sheet, which is applied as an inner liner.

The inner liner of the present invention thus obtained, which has an oxygen permeation rate of less than 15×10⁻³ ccm/m²·24 hr·atm, and a fracture ductility of more than 200% at the room temperature, causes no fracture even by severe deformation during the tire shaping process, facilitating the tire manufacture, and provides good air tightness and oxygen leakage preventive ability.

Preferably, the non-drawn sheet has the maximum value of the complete elastic deformation interval, that is, a yield point of more than 10% at −35° C.

The inner liner of the tire thus manufactured is also deformed under different deformation conditions, which cause a deterioration of the performance of the inner liner. Especially, the deformation caused under severe conditions due to temperature variations during the use of the tire further deteriorates the performance of the inner liner.

Accordingly, the inner liner of the present invention as a non-drawn sheet has a yield point of more than 10% at −35° C., so it can maintain the performance of the inner liner in spite of a tire deformation under normal weather conditions and a deformation under severe cold conditions of −35° C.

In applying the inner liner, carcass layers may be affixed to both sides of the inner liner so as to compensate for scratch resistance.

For this purpose, an adhesive layer must be provided on either side of the inner liner by adhesive coating. In addition, a peeling paper is used so as to prevent adhesion between the both-sided adhesive layers for easier packaging in the roll form.

### BEST MODE FOR CARRYING OUT THE INVENTION

Hereinafter, the present invention will be described in detail by way of the following examples, which are not intended to limit the scope of the present invention.

### EXAMPLE 1

A resin composition including a blend of nylon 6 and a polyamide elastomer at a weight ratio of 80 to 20 was melt at 260° C., extruded with a annular die, and quenched to obtain a 50 μm-thickness non-drawn polyamide sheet.

### EXAMPLE 2

Procedures were performed to prepare a 50 μm-thickness cast polyamide sheet in the same manner as described in Example 1, excepting that the weight ratio of nylon 6 to polyamide elastomer was 70 to 30.

### COMPARATIVE EXAMPLE 1

This comparative example describes an example of a stretched film formed from nylon 6 alone without using any elastomer. Nylon 6 was melt at 260° C., extruded with a annular die, and quenched to obtain a 50 μm-thickness non-drawn polyamide sheet. Subsequently, the non-drawn polyamide sheet was drawn 2.7×2.7 times at a temperature between the glass transition temperature and the heat crystallization temperature and annealed at a temperature below the melting point to obtain a 15 μm-thickness drawn polyamide film.

### COMPARATIVE EXAMPLE 2

Procedures were performed to prepare a 50 μm-thickness non-drawn polyamide sheet in the same manner as described in Example 1, excepting that nylon 6 was used alone without any elastomer.

### COMPARATIVE EXAMPLE 3

Procedures were performed to prepare a 50 μm-thickness non-drawn polyamide sheet in the same manner as described in Example 1, excepting that the weight ratio of nylon 6 to polyamide elastomer was 50 to 50.

### COMPARATIVE EXAMPLE 4

Procedures were performed to prepare a 50 μm-thickness non-drawn polyamide sheet in the same manner as described in Example 1, excepting that polyamide elastomer was used alone without nylon 6.

### COMPARATIVE EXAMPLE 5

Procedures were performed to prepare a 15 μm-thickness drawn polyamide film in the same manner as described in Comparative Example 1, excepting that nylon 6 and polyamide elastomer were mixed at a weight ratio of 80 to 20 instead of using nylon 6 alone.

### COMPARATIVE EXAMPLE 6

Procedures were performed to prepare a 15 μm-thickness drawn polyamide film in the same manner as described in Comparative Example 1, excepting that nylon 6 and polyamide elastomer were mixed at a weight ratio of 70 to 30 instead of using nylon 6 alone.

### COMPARATIVE EXAMPLE 7

Procedures were performed to prepare a 15 μm-thickness drawn polyamide film in the same manner as described in Comparative Example 1, excepting that nylon 6 and polyamide elastomer were mixed at a weight ratio of 50 to 50 instead of using nylon 6 alone.

### COMPARATIVE EXAMPLE 8

Procedures were performed to prepare a 15 μm-thickness drawn polyamide film in the same manner as described in Comparative Example 1, excepting that polyamide elastomer was used alone instead of nylon 6.

The samples obtained in Examples 1 and 2 and Comparative Examples 1 to 8 were used to perform a tire manufacture test. The results are presented in Table 1.

The tire manufacture test was performed according to a general tire manufacturing method.

TABLE 1

| | Tire | |
|---|---|---|
| Sample | manufacture test | Reference |
| Example 1 | Passed | — |
| Example 2 | Passed | — |
| Comparative example 1 | Rejected | Fracture during shaping |
| Comparative example 2 | Passed | — |
| Comparative example 3 | Passed | — |
| Comparative example 4 | Passed | — |
| Comparative example 5 | Rejected | Fracture during shaping |
| Comparative example 6 | Rejected | Fracture during shaping |
| Comparative example 7 | Rejected | Fracture during shaping |
| Comparative example 8 | Rejected | Fracture during shaping |

As shown in Table 1, all the samples after drawing and annealing processes had fractures caused during the shaping process, resulting in a failure of tire manufacture.

The samples passed in the tire manufacture test, that is, the non-drawn sheets obtained in Examples 1 and 2 and Comparative Examples 2, 3 and 4 were analyzed in regard to oxygen permeation, room-temperature tensile strength, and low-temperature tensile strength. The results are presented in Table 2.

The specific measurement methods are described as follows.

(1) Oxygen permeation rate: ASTM D 3895, with an oxygen permeation analyzer (Model 8000, Illinois Instruments Co., Ltd.)

(2) Room-Temperature Tensile Strength

Instrument—Universal Material Tester (Model 4204, Instron Co., Ltd.)

Head Speed—300 mm/min

Grip Distance—100 mm

Sample Width—10 mm

Temperature—Room Temperature (25° C., 60 RH %)

(3) Low-Temperature Tensile Strength

Instrument—Universal Material Tester (Model 4204, Instron Co., Ltd.)

Head Speed—300 mm/min

Grip Distance—35 mm

Sample Width—50.8 mm

Temperature—−35° C.

TABLE 2

| | Oxygen permeation rate |
|---|---|
| Sample | (ccm/m² · 24 hr · atm) |
| Example 1 | 4.9 × 10⁻³ |
| Example 2 | 6.2 × 10⁻³ |
| Comparative example 2 | 1.8 × 10⁻³ |
| Comparative example 3 | 17.9 × 10⁻³ |
| Comparative example 4 | 154.8 × 10⁻³ |

As can be seen from Table 2, when the content of the polyamide elastomer amounts to exceed 40 wt. %, the films had such an oxygen permeation rate to exhibit a poor gas barrier property inadequate to the air insulation of the tire. Therefore, the films were difficult to use as a tire inner liner.

TABLE 3

| | Room temperature | | |
|---|---|---|---|
| | (25° C.) | Low temperature (−35° C.) | |
| | Maximum fracture | Yield Point | Maximum fracture |
| | elongation (%) | (%) | elongation (%) |
| Example 1 | 412.2 | 12.7 | 140 |
| Example 2 | 485.6 | 12.9 | 151 |
| Comparative | 362.4 | 7.3 | 60 |
| example 2 | | | |
| Comparative | 543.2 | 13.8 | 167 |
| example 3 | | | |
| Comparative | 635.2 | 24.2 | 230 |
| example 4 | | | |

As can be seen from Table 3, all the samples passed in the tire manufacture test had a room-temperature elongation of more than 300% high enough to stand a deformation of about 200% at the room temperature during the shaping process.

In the low-temperature measurements, the sample of the Comparative Example 2 had a yield point of 7.3%, which means that the tire manufactured cannot guarantee a complete elasticity recovery under a deformation of more than 7.3% at a low temperature of −35° C. while running and possibly has a permanent deformation to cause a serious problem in maintaining the air tightness. In addition, all the samples other than the sample of the Comparative Example 2 had a yield point of more than 10%, implementing that the tire manufactured realizes a complete elasticity recovery under a deformation of less than 10% even at a low temperature of −35° C. while running, without affecting other properties such as durability. This means that these samples cause no problem in tire manufacture and operation, when considering that their deformation is less than 10% during an actual operation and that the lowest temperature the tire should be durable is −35° C.

### INDUSTRIAL APPLICABILITY

As described above in detail, when a non-drawn sheet is formed from a polymer composition including a thermoplastic resin and an elastomer according to the present invention to have an oxygen penetration rate of less than 15×10⁻³ ccm/m²·24 hr·atm, and a fracture elongation of more than 200% at the room temperature and applied to an inner liner, the tire thus manufactured has no fracture under a severe deformation during the tire shaping process, facilitating the tire manufacture, and exhibits an air permeation preventive property as an excellent air permeation preventive layer.

While this invention has been described in connection with the embodiments, it is to be understood to those skilled in the art that the invention is not limited to the disclosed embodiments, but, on the contrary, is intended to cover various modifications and equivalent arrangements. Particularly, the number of layers is flexible and the core/shell structure can have a gradient. Accordingly, the technical coverage of the present invention is to be included within the spirit and scope of the appended claims.

What is claimed is:

1. An inner liner of pneumatic tires, being formed from a non-drawn film of a polymer composition including 60 to 90 wt. % of a thermoplastic resin and 10 to 40 wt. % of an elastomer, the non-drawn film having an oxygen permeation rate of less than 15×10⁻³ ccm/m²·24 hr·atm, and a fracture elongation of more than 200% at the room temperature.

2. The inner liner of pneumatic tires as claimed in claim 1, wherein the non-drawn film has a yield point of more than 10% at −35° C.

3. The inner liner of pneumatic tires as claimed in claim 1, wherein the thermoplastic resin includes a polyamide resin.
